(19) United States
(12) Patent Application Publication
(10) Pub. No.: US 2026/0204533 A1
(43) Pub. Date: Jul. 16, 2026

(54) Mass Spectrometry Device

(71) Applicant: Hitachi High-Tech Corporation, Minato-ku, Tokyo (JP)

(72) Inventors: Hiroyuki YASUDA, Tokyo (JP); Koji ISHIGURO, Tokyo (JP); Akimasa OSAKA, Tokyo (JP); Isao FURUYA, Tokyo (JP); Suguru KONDO, Tokyo (JP)

(21) Appl. No.: 19/135,864

(22) PCT Filed: Dec. 1, 2023
(86) PCT No.: PCT/JP2023/043030

§ 371 Date: Jun. 5, 2025

(30) Foreign Application Priority Data
Dec. 20, 2022 (JP) 2022-202812

(51) Int. Cl. H01J 49/06; H01J 49/24

(52) U.S. Cl. CPC H01J 49/068; H01J 49/063; H01J 49/24

(57) ABSTRACT

Provided is a mass spectrometer capable of easily maintaining a plurality of multipole electrodes. The mass spectrometer includes a plurality of multipole electrodes 210, 220, and 230 accommodated in a vacuum chamber 250, and one holding member 620 configured to hold the plurality of multipole electrodes 210, 220, and 230 such that ion optical axes of the plurality of multipole electrodes 210, 220, and 230 coincide with each other. The holding member 620 is configured to travel on a travel rail 610 and move the plurality of multipole electrodes 210, 220, and 230 to the outside of the vacuum chamber 250.

### TECHNICAL FIELD

The present invention relates to a mass spectrometer including a plurality of multipole electrodes.

### BACKGROUND ART

A mass spectrometer is a device that ionizes a sample and analyzes ions according to a mass-to-charge ratio. Generally, the mass spectrometer includes an ion source that ionizes the sample, a mass analysis unit that separates the ions according to the mass-to-charge ratio, and a detection unit that detects an amount of ions that has passed through the mass analysis unit. The mass analysis unit is housed in a vacuum chamber, but may be taken out to an outside of the vacuum chamber for maintenance or parts replacement.

For example, Patent Literature 1 discloses a configuration that allows an ion guide assembly having multipole electrodes to be taken out from the vacuum chamber.

### Citation List

### Patent Literature

Patent Literature 1: WO 2019/122921

### SUMMARY OF INVENTION

### Technical Problem

The multipole electrodes of the mass spectrometers may be taken out to an outside of the vacuum chamber for maintenance (replacement or cleaning). However, Patent Literature 1 focuses only on an assembly having one multipole electrode and does not consider the case where a plurality of multipole electrodes is used.

An object of the present invention is to provide a mass spectrometer capable of easily maintaining a plurality of multipole electrodes.

### Solution to Problem

In order to solve the above problems, a mass spectrometer of the present invention includes: a plurality of multipole electrodes accommodated in a vacuum chamber; and one holding member configured to hold the plurality of multipole electrodes such that ion optical axes of the plurality of multipole electrodes coincide with each other.

### ADVANTAGEOUS EFFECTS OF INVENTION

According to the present invention, since one holding member holds a plurality of multipole electrodes, the plurality of multipole electrodes can be easily maintained only by taking the one holding member out of the vacuum chamber.

Furthermore, according to the present invention, the plurality of multipole electrodes is held by the one holding member such that ion optical axes thereof coincide with each other, therefore deviations of the ion optical axes due to attachment and detachment can be prevented compared to the case where the plurality of multipole electrodes are handled separately.

Objects, configurations, and effects described above will be apparent from the description of the following embodiments.

### BRIEF DESCRIPTION OF DRAWINGS

FIG. 1 is a schematic diagram showing an overall configuration of a mass spectrometer 1 according to an embodiment.

FIG. 2 is a schematic diagram showing a detailed configuration of an analysis unit 200 and periphery of the analysis unit 200 according to the embodiment.

FIG. 3 is an enlarged diagram of a cam mechanism 630 according to the embodiment.

FIG. 4 is a diagram showing a state in which a holding member 620 according to the embodiment is raised.

FIG. 5 is a diagram showing a state in which the holding member 620 according to the embodiment has moved along a travel rail 610.

### DESCRIPTION OF EMBODIMENTS

Hereinafter, one embodiment of the present disclosure will be described with reference to the accompanying drawings. The embodiment is illustrative for explaining the present invention, and some parts have been omitted or simplified as appropriate for clarity of explanation. The present invention can also be implemented in various other embodiments. Unless otherwise limited, each component can be singular or plural.

The location, size, shape, scope of each component shown in the drawings may not represent the actual location, size, shape, scope to facilitate understanding of the present invention. Therefore, the present invention is not necessarily limited to the location, size, shape, scope disclosed in the drawings.

In cases where there are multiple components having the same or similar functions, they may be described by using the same reference numerals with different subscripts. If it is not needed to distinguish between these multiple components, subscripts may be omitted from the description.

### Mass Spectrometer 1

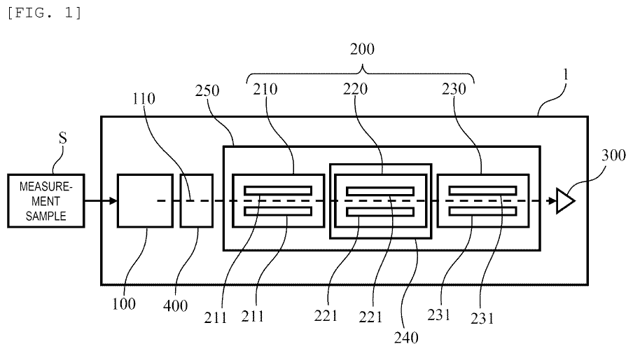

FIG. 1 is a schematic diagram showing an overall configuration of a mass spectrometer 1 according to an embodiment. The mass spectrometer 1 mainly includes an ion source 100, an analysis unit 200 that analyzes ions supplied from the ion source 100 by mass separation, and a detector 300 that detects the ions. In the mass spectrometer 1, a measurement sample S supplied by a pump such as a liquid chromatograph is ionized by the ion source 100. Since the ion source 100 is under an atmospheric pressure and the analysis unit 200 operates in a vacuum atmosphere, ions 110 are introduced into an inside of a vacuum chamber 250 via an interface 400 between the atmosphere and the vacuum atmosphere. A vacuum pump (not shown) is provided in the vacuum chamber 250, and the inside of the vacuum chamber 250 is evacuated by the vacuum pump.

### Analysis Unit 200

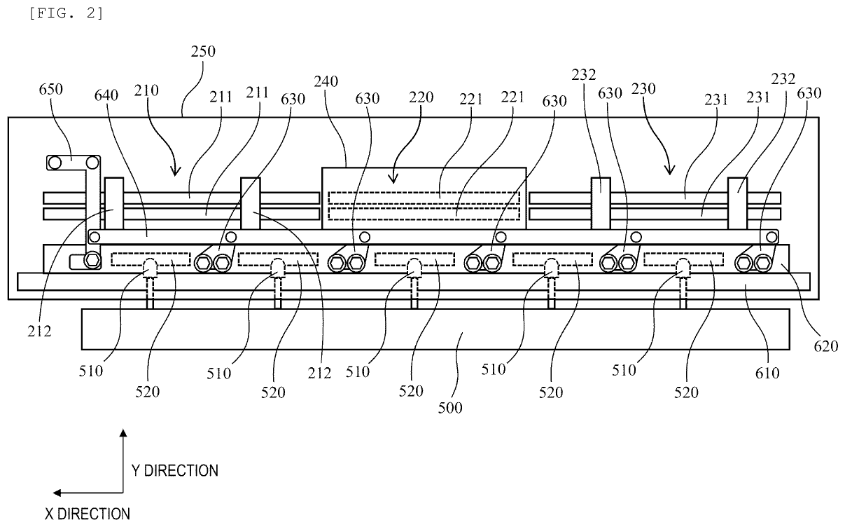

The analysis unit 200 according to the present embodiment is a triple multipole mass spectrometer, and has a plurality of (three according to the present embodiment) multipole electrodes 210, 220, and 230. The multipole electrodes 210, 220 and 230 are accommodated in the vacuum chamber 250. Each of the plurality of multipole electrodes 210, 220 and 230 has four rod electrodes 211, 221 and 231, respectively. The number of rod electrodes is not limited to four. The four rod electrodes 211 of the multipole electrode 210 and the four rod electrodes 231 of the multipole electrode 230 are respectively fixed onto a holding member 620 (see FIG. 2) by holders 212 and 232. The four rod electrodes 221 of the multipole electrode 220 are also fixed onto the holding member 620 (see FIG. 2) by a holder not shown.

The ions 110 generated from the ion source 100 have various masses, but only the target ions derived from the measurement sample are selectively passed through the multipole electrode 210. The second-stage multipole electrode 220 is arranged in a collision cell 240, into which a collision gas (such as nitrogen gas or argon gas) for dissociating target ions is introduced. The multipole electrode 220 generates fragment ions by colliding the target ions that have passed through the multipole electrode 210 with a collision gas. The fragment ions generated enter the third-stage multipole electrode 230. The multipole electrode 230 selectively passes only the desired fragment ions. The desired fragment ions that have passed through the multipole electrode 230 are detected by the detector 300.

FIG. 2 is a schematic diagram showing a detailed configuration of an analysis unit 200 and periphery of the analysis unit 200 according to the present embodiment. Next, the detailed configuration of the analysis unit 200 and periphery thereof will be described with reference to FIG. 2.

### Power Source Configuration

Referring to FIG. 2, a power source configuration for supplying power to loads in the vacuum chamber 250 will be described. A power source 500 is provided outside the vacuum chamber 250 to supply power to the loads (multipole electrodes 210, 220, 230, etc.) in the vacuum chamber 250. Furthermore, a plurality of power receiving substrates 520 that receives power from the power source 500 is attached to a holding member 620 described later. Power supplied from the power source 500 is received by a plurality of power receiving substrates 520 via a plurality of supply terminals 510. The supply terminals 510 are electrically connected to the power receiving substrates 520 and supplies the power supplied from the power source 500 to the power receiving substrates 520. The power receiving substrates 520 supply power to each load (e.g., multipole electrodes 210, 220, 230) in the vacuum chamber 250.

### Movement Mechanism

Next, a movement mechanism for moving the plurality of multipole electrodes 210, 220, and 230 will be described. The movement mechanism has the one holding member 620 that holds the plurality of multipole electrodes 210, 220, and 230. The holding member 620 may be comprised of a single part, or it may be a structure that is integrally constructed by combining multiple parts. The holding member 620 holds the plurality of multipole electrodes 210, 220 and 230 such that respective ion optical axes of the plurality of multipole electrodes 210, 220 and 230 coincide with each other. The ion optical axis of the multipole electrode 210 is a central axis that is equidistant from the four rod electrodes 211, and the four rod electrodes 211 are arranged at equal angular intervals (90°) around the central axis. Ion optical axes of the multipole electrodes 220 and 230 are similar to that of the multipole electrode 210, therefore a description thereof will be omitted.

In the vacuum chamber 250, a travel rail 610 is laid along an ion optical axis direction (X direction). The holding member 620 moves along the travel rail 610. By moving the holding member 620 along the travel rail 610, the plurality of multipole electrodes 210, 220, and 230 held by the holding member 620 can be moved from inside to outside or outside to inside the vacuum chamber 250.

A plurality of cam mechanisms 630 are attached to the holding member 620. Details of the cam mechanism 630 will be described later.

A connecting member 640 is attached to one end of the cam mechanism 630. The connecting member 640 connects an operation lever 650 operated by a user to the cam mechanism 630. The connecting member 640 rotates the cam mechanism 630 by rotation of the operation lever 650 to raise the holding member 620. The connecting member 640 moves the holding member 620 and the cam mechanism 630 along the X direction by moving the operation lever 650 in the X direction.

The operation lever 650 is a user-operated lever and is rotatably connected to the holding member 620. Furthermore, the connecting member 640 is connected to the operation lever 650. When the operation lever 650 is rotated by user operation, the connecting member 640 is pulled in the X direction, causing the cam mechanism 630 to rotate. When the cam mechanism 630 rotates, the holding member 620 attached to the cam mechanism 630 rises, and the plurality of multipole electrodes 210, 220 and 230 mounted on the holding member 620 rises. Thus, the cam mechanism 630 separates the power receiving substrates 520 from the supply terminals 510 by user's rotary operation of the operation lever 650.

When the operation lever 650 is moved along the X direction by the user operation, the holding member 620 is pulled in the X direction (toward the ion source 100), and the plurality of multipole electrodes 210, 220 and 230 mounted on the holding member 620 moves in the X direction. Thus, by user's slide operation of the operation lever 650, the holding member 620 is moved to the outside of the vacuum chamber 250.

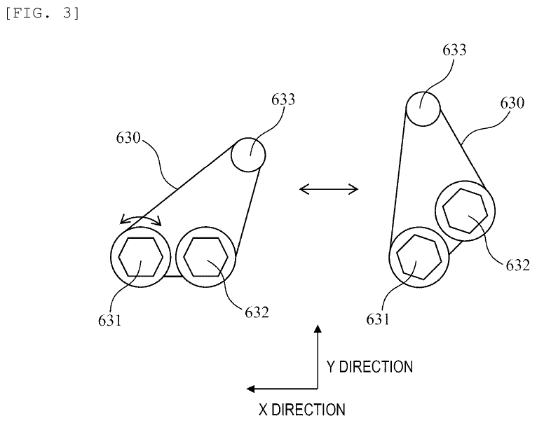

FIG. 3 is an enlarged diagram of a cam mechanism 630 according to the present embodiment. The cam mechanism 630 is a separating mechanism that separates the power receiving substrates 520 attached to the holding member 620 side from the supply terminals 510 attached to the vacuum chamber 250 side. The cam mechanism 630 has a rotating portion 631 that rotates the cam mechanism 630, a holding member attachment portion 632 that is attached to the holding member 620, and a connecting member attachment portion 633 that is attached to the connecting member 640. By rotating the operation lever 650, a force is transmitted to the cam mechanism 630 via the connecting member 640, causing the cam mechanism 630 to rotate around the rotating portion 631. When the cam mechanism 630 rotates, the holding member 620 attached to the holding member attachment portion 632 rises in the Y direction.

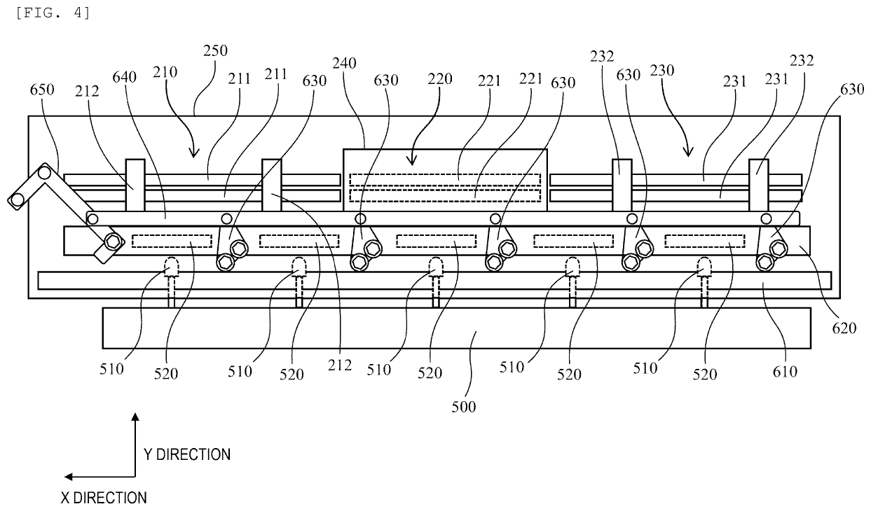

FIG. 4 is a diagram showing a state in which a holding member 620 according to the present embodiment is raised. When the operation lever 650 is rotated to raise the holding member 620 in the Y direction, the power receiving substrates 520 attached to a lower portion of the holding member 620 also rises in the Y direction. At this time, the power receiving substrates 520 are separated from the supply terminals 510, and the power source 500 and the power receiving substrates 520 are electrically disconnected.

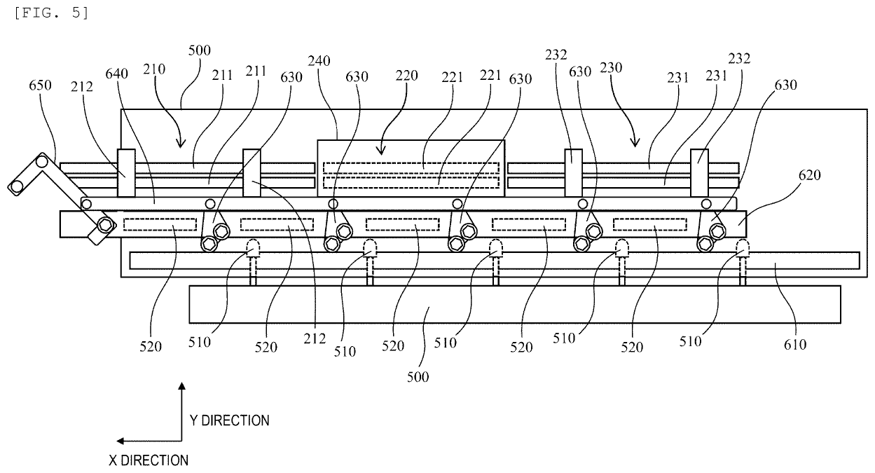

FIG. 5 is a diagram showing a state in which the holding member 620 according to the present embodiment has moved along the travel rail 610. According to the present embodiment, with the holding member 620 raised, that is, with the power source 500 and the power receiving substrates 520 electrically disconnected, pulling the operation lever 650 in the X direction causes the holding member 620 to move in the X direction along the travel rail 610. It allows the plurality of multipole electrodes 210, 220, and 230 mounted on the holding member 620 to be moved collectively to the outside of the vacuum chamber 250.

As shown in FIGS. 4 and 5, according to the present embodiment, a separating direction (Y direction) that the cam mechanism 630 (separating mechanism) separates the power receiving substrates 520 and the supply terminals 510 is different from a moving direction (X direction) that the holding member 620 is moved to the outside of the vacuum chamber 250.

### Effects of the Embodiment

According to the present embodiment, the one holding member 620 holds the plurality of multipole electrodes 210, 220, and 230, therefore the plurality of multipole electrodes 210, 220, and 230 can be maintained collectively and easily only by moving the holding member 620 to the outside of the vacuum chamber 250.

Furthermore, according to the present embodiment, the plurality of multipole electrodes 210, 220, and 230 are held in the one holding member 620 such that the ion optical axes of the plurality of multipole electrodes 210, 220, and 230 coincide with each other. Therefore, deviations of the ion optical axes due to attachment and detachment can be prevented compared to the case where the plurality of multipole electrodes is handled separately. It results in improving an ion transmission rate.

According to the present embodiment, the plurality of multipole electrodes 210, 220, and 230 can be moved to the outside of the vacuum chamber 250 by providing the movement mechanism with the travel rail 610 and the holding member 620 that travels on the travel rail 610. As a result, maintenance of the plurality of multipole electrodes 210, 220, and 230 can be performed collectively outside the vacuum chamber 250.

According to the present embodiment, the plurality of multipole electrodes 210, 220, and 230 can be moved to the outside of the vacuum chamber 250 with the electrical connection between the power receiving substrates 520 and the supply terminals 510 disconnected. By raising the holding member 620, a movement of the holding member 620 can be prevented from interfering with the supply terminals 510.

According to the present embodiment, by making the separating direction (Y direction) between the receiving substrates 520 and the supply terminals 510 different from the moving direction (X direction) of the holding member 620, the receiving substrates 520 and the supply terminals 510 can be laid out without being restricted by the moving direction of the holding member 620.

According to the present embodiment, a first operation (rotary operation) of the operation lever 650 separates the power receiving substrates 520 from the supply terminals 510, and a second operation (slide operation) of the operation lever 650 can move the holding member 620 to the outside of the vacuum chamber 250. That is, according to the present embodiment, by simply operating the operation lever 650, both the separation of the power receiving substrates 520 from the supply terminals 510, and a slide movement of the holding member 620 can be performed.

### Modification

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1: mass spectrometer
100: ion source
200: analysis unit
210, 220, 230: multipole electrode
211, 221, 231: rod electrode
212, 232: holder
240: collision cell
250: vacuum chamber
300: detector
400: interface
500: power source
510: supply terminal
520: power receiving substrate
610: travel rail
620: holding member
630: cam mechanism
631: rotating portion
632: holding member attachment portion
633: connecting member attachment portion
640: connecting member
650: operation lever

1.-6. (canceled).

7. A mass spectrometer comprising:
a plurality of multipole electrodes accommodated in a vacuum chamber;
one holding member configured to hold the plurality of multipole electrodes such that ion optical axes of the plurality of multipole electrodes coincide with each other, and configured to enable movement of the plurality of multipole electrodes to an outside of the vacuum chamber;
a power source provided outside the vacuum chamber;
a power receiving substrate provided in the vacuum chamber;
a supply terminal configured to electrically connect the power source and the power receiving substrate;
a separating mechanism configured to separate the power receiving substrate attached to a holding member side from the supply terminal attached to a vacuum chamber side; and
an operation lever attached to the holding member and configured to operate the separating mechanism, wherein
the holding member moves the plurality of multipole electrodes to the outside of the vacuum chamber in a state in which the electrical connection between the power receiving substrate and the supply terminal is cut off,
a separating direction in which the power receiving substrate and the supply terminal are separated by the separating mechanism is different from a moving direction in which the holding member is moved to the outside of the vacuum chamber, and
the separating mechanism separates the power receiving substrate and the supply terminal by a first operation of the operation lever performed by a user, and the holding member is moved to the outside of the vacuum chamber by a second operation of the operation lever performed by the user.

8. The mass spectrometer according to claim 7, wherein
the holding member is configured to enable movement from the inside of the vacuum chamber to the outside of the vacuum chamber toward an ion source configured to supply ions.
